(19) United States
(12) Patent Application Publication
(10) Pub. No.: US 2024/0111701 A1
(43) Pub. Date: Apr. 4, 2024

(54) DYNAMIC SWITCHING OF DATA TRANSFERS BETWEEN SIDEBAND AND MAINBAND

(71) Applicant: Intel Corporation, Santa Clara, CA (US)

(72) Inventors: Aruni P. Nelson, Folsom, CA (US); Enrico David Carrieri, Placerville, CA (US); Rolf Kuehnis, Portland, OR (US); Peter Onufryk, Flanders, NJ (US); Sridhar Muthrasanallur, Bangalore (IN)

(21) Appl. No.: 18/539,063

(22) Filed: Dec. 13, 2023

(51) Int. Cl. G06F 13/40; G06F 13/22; G06F 13/42

(52) U.S. Cl. CPC G06F 13/4031; G06F 13/225; G06F 13/4221

(57) ABSTRACT

Embodiments herein relate to a universal component interconnect express (UCIe) link that includes a mainband and a sideband. One or more pieces of logic may identify a data that is to be transmitted on the sideband. The logic may then identify, based on factors such as a characteristic of the data or a characteristic of the link, whether to transmit the data on the mainband. Other embodiments may be described and/or claimed.

### BACKGROUND

The UCIe specification (Universal Chiplet Interconnect Express) defines a high-speed, high-power mainband, combined with a low-speed, low-power sideband connection.

Legacy implementations of UCIe support a single sideband connection per UCIe module for initialization, Link training and configuration reads/writes, and bare minimal debug purposes. This sideband connection may support up to an 800 megahertz (MHz) clock, which may result in a maximum theoretical raw bandwidth of 800 megatransfers per second (MTs). This sideband connection alone may be insufficient for higher bandwidth use cases.

For example, debug trace or telemetry may require higher peak bandwidths than the sideband connection may offer. When the electronic device that is using the UCIe connection is in the low power state, the sideband bandwidth may be sufficient. However, when the electronic device is in a more active state, there may be a significant increase in data to be transferred over the UCIe connection, which may require higher bandwidths than may be provided by the sideband. As such, sending this higher amount of data over the sideband may result in loss of data.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of logic that may be used to dynamically switch between the sideband and the mainband of a UCIe module.

FIG. 2 illustrates an example process flow to be performed by the logic of FIG. 1, in accordance with various embodiments.

FIG. 3 illustrates an example technique to be performed by one or more elements of the logic described herein, in accordance with various embodiments.

FIG. 4 illustrates an alternative example technique to be performed by one or more elements of the logic described herein, in accordance with various embodiments.

FIG. 5 illustrates an example computing system suitable for practicing various aspects of the disclosure, in accordance with various embodiments.

FIG. 6 illustrates an example non-transitory computer-readable storage medium having instructions configured to practice all or selected ones of the operations associated with the processes described in reference to FIG. 5 and/or some other process or operation described herein.

### DETAILED DESCRIPTION

As noted, a legacy UCIe link may include a mainband that has higher throughput/bandwidth than the relatively lower power/lower-bandwidth sideband. However, the legacy configuration of a single mainband and a single sideband may result in bandwidth limitations when a significant amount of data is to be transmitted over the sideband. Specifically, in legacy UCIe links, the sideband may be reserved for data related to link initialization, link training, configuration reads/writes, debug, telemetry, etc. It will be understood that these types of data are used herein for the sake of example only, and additional/alternative types of data may be transmitted on the sideband in other scenarios/embodiments. However, in situations where the data to be transmitted on the sideband is higher than the sideband bandwidth, undesirable results may occur such as data latency, loss of data, etc.

Embodiments herein may relate to dynamically switching data transfer between the sideband and the mainband connection of a UCIe link depending on various factors related to the data, the sideband, and/or the mainband. The factors may include, for example, the priority of data sent on the sideband; in-order transmission of data packets; quality of service needed for critical data on sideband; power state of the UCIe link; current bandwidth utilization of mainband, etc. It will be understood that these factors are intended as example factors, and other embodiments may use fewer factors, or one or more additional or alternative factors.

This dynamic switching of data may be performed by various types of logic, which may be implemented as hardware, software, firmware, and/or some combination thereof. One such piece of logic is referred to herein as transfer manager logic. The transfer manager logic may reside in the UCIe protocol layer, and may determine the bandwidth demand of the data that is to be transmitted over the UCIe link.

Another such piece of logic is referred to herein as transfer arbiter logic. The transfer arbiter logic may reside in the UCIe die-to-die adapter. The transfer arbiter logic may receive an indication from the transfer manager logic regarding whether the data is to be routed over the mainband or sideband. The transfer arbiter logic may then identify, based on one or more factors related to use of the mainband and/or sideband, whether to route the data over the mainband or sideband of the UCIe link In some embodiments, the transfer arbiter logic may be implemented as a 1:2 multiplexer.

Embodiments may enable a variety of advantages. For example, embodiments may allow dynamic switching between sideband and mainband connections of UCIe based on the usage scenario of the UCIe link at the time that the data is to be transferred over the link. Embodiments may provide a cost-effective solution to provide increased bandwidth based on the usage scenario of the UCIe link compared to the legacy UCIe specification and/or legacy implementations thereof. Embodiments may allow for more efficient utilization of the UCIe link based on various scenarios, as will be described in greater detail below.

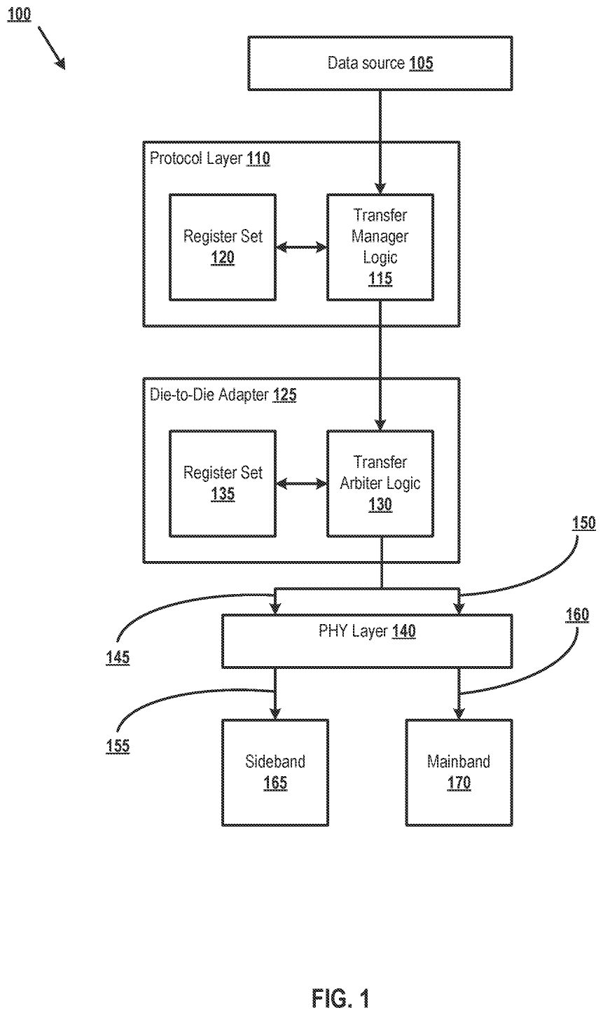

FIG. 1 depicts an example architecture 100, in accordance with various embodiments. It will be understood that FIG. 1 is intended as a very high-level example of such an architecture, and other embodiments may have more, fewer, or different elements than are depicted in FIG. 1. For example, some embodiments may include more or fewer of the various elements than are shown, elements may be combined with one another (e.g., the register set 120 and the transfer manager logic 115 may be combined into a single logic element such as a single piece of hardware or firmware), or elements may be split into multiple elements. It will further be understood that the specific names or references used herein (e.g., transfer manager logic or transfer arbiter logic) are examples of such a name, and in other embodiments a differently-named element may perform a same or similar function. Embodiments herein should not be construed to be limited to the specific names given to various of the components.

The architecture may include a data source 105. The data source may provide the data that is to be transmitted over the UCIe link. The data source may be, for example, a central processing unit, an accelerator, an input/output (I/O) tile, etc.

The data may be provided from the data source 105 to the protocol layer 110. The protocol layer may include the transfer manager logic 115, which may be communicatively coupled with a register set 120. The register set 120 may serve as a type of memory that is accessible by the transfer manager logic 115. In some embodiments, the register set 120 may include one or more indications related to allowing the transfer manager logic 115 to advertise (e.g., to the data source 105) that the architecture 100 is capable of dynamic switching between the mainband and the sideband. In some embodiments, the register set 120 may include indications related to the type of data that is capable of being dynamically switched between the mainband and the sideband (e.g., it may be impermissible for certain types of data to be switched from transfer over the sideband to transfer over the mainband).

The transfer manager logic 115 may be configured to identify, based on a variety of factors or parameters as will be explained in greater detail below, whether the data should be transmitted over the mainband or the sideband. The factors or parameters may be based on, for example, an indication retrieved from the register set 120, one or more characteristics of the data itself, a characteristic of the UCIe link, and/or some other type of factor or parameter.

Based on the identification by the transfer manager logic 115, the transfer manager logic 115 may output, to the die-to-die adapter 125 (or, more particularly, to the transfer arbiter logic 130 of the die-to-die adapter 125) an indication of whether the data is to be transmitted over the mainband or the sideband of the UCIe link.

The transfer arbiter logic 130 may be communicatively coupled with a register set 135 of the die-to-die adapter 125 which may include, for example, information related to configuration of the UCIe link and/or some other type of information. Based on the indication received from the transfer manager logic 115, information retrieved from the register set 135, information retrieved regarding the current status of the mainband and/or sideband, and/or some other type of information or characteristic, the transfer arbiter logic 130 may output the data to the PHY layer 140 (or, more specifically, a logic of the PHY layer 140) along with an indication of whether the data is data 150 that is to be transmitted over the mainband or data 145 that is to be transmitted over the sideband of the UCIe link.

The PHY layer 140 may process the data 145 or 150 received from the die-to-die adapter 125, and then output the data as instructed. Specifically, the PHY layer 140 may output sideband data 155 over the sideband 165, and may output mainband data 160 over the mainband 170 as shown.

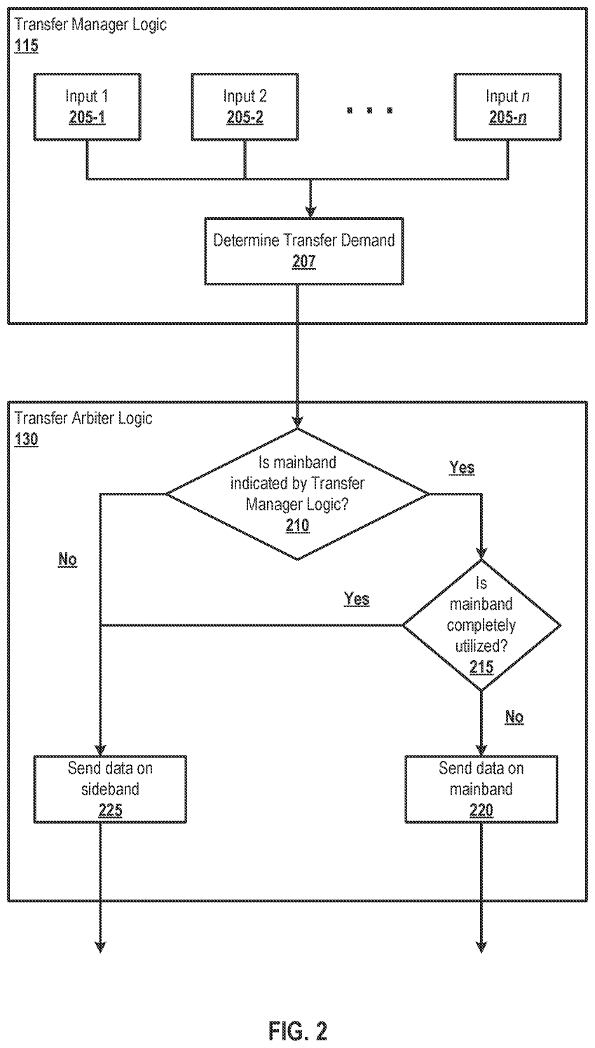

FIG. 2 depicts an example process flow related to the transfer manager logic 115 and the transfer arbiter logic 130. It will be understood that the process flow of FIG. 2 is intended as a very high level example of such a process flow, and other embodiments may include more/fewer/different elements than are depicted in FIG. 2.

As noted, the transfer manager logic 115 may take, as inputs, a plurality of factors or characteristics related to elements such as the state of the UCIe link, the data, etc. The inputs are depicted in FIG. 2 as inputs 205-1, 205-2, . . . , 205-n to indicate that there may be some plurality of n inputs, although in other embodiments there may be as few as one input. Collectively, the inputs are referred to as inputs 205.

The inputs 205 may be drawn from the register set 120 such as through identification of one or more values or parameters of a pre-programmed table or other data structure of the register set 120, identified by the transfer manager logic 115 (e.g., based on metadata of the data that may be provided by a source such as the data source 105), or identified in some other way. A non-limiting list of example factors or characteristics may include the following (although, it will be recognized that other embodiments may include more/fewer/different factors):

Data size and type—This factor may relate to the specific type of the data, or the amount (e.g., size) of data that is to be transferred. For example some data may be classified as “High Bandwidth Demand Debug Type” data, for which the sideband connection may be insufficient.

Data priority—This factor may relate to the priority of the data that is to be transferred. For example a certain data type may be of high priority which requires instant transmission. As one example, this data type may be or relate to functional data or debug data.

Packet ordering requirements—Certain data types such as a stream of data may require in-order transmission of data. In this situation, switching of data transmission mid-stream between the sideband and mainband may be prohibited, or additional synchronization packets and identifiers in the data packet headers may be needed if the transmission of data is switched mid-stream between the sideband and the mainband.

Required quality of service—This factor may relate to the quality of service required by the data. For example, data with a high quality of service requirements may be allowed to be invasive and “disturb” or interrupt already ongoing operations. As another example, data with a lower quality of service may be referred to as “best effort” and may be transmitted as resources become available.

UCIe link power state—This factor may relate to the specific power state of the UCIe link at the time that the data is to be transmitted. For example, the system may intend to keep the UCIe link in a lower power state where keeping the sideband connection awake/functional may be allow for low-bandwidth/slow data transfer, and the UCIe mainband connection may be in sleep/low power state. Alternatively, the UCIe link may be in a high-power (also referred to as “active” or “awake”) state such that data transfer is allowed over the mainband and the sideband.

Based on the various inputs 205, the transfer manager logic 115 may determine the transfer demand of the data that is to be transmitted as 207. Specifically, the transfer manager logic 115 may identify whether it would be preferable from a standpoint of data integrity, power use, efficient bandwidth usage, and/or some other criteria to transfer the data on the mainband or the sideband. The transfer manager logic 115 may output such an indication to the transfer arbiter logic 130.

The transfer arbiter logic 130 may identify, at 210, whether the mainband is indicated by the transfer manager logic 115. If the answer to that question is no, then the transfer arbiter logic may identify that the data is to be sent on the sideband at 225, and output the data accordingly (e.g., to the PHY layer 140 as described above with respect to elements 140 and 145).

By contrast, if it is determined at 210 that the mainband is indicated by the transfer manager logic 115, then the transfer arbiter logic may then identify, at 215, whether the mainband is completely utilized. Specifically, the transfer arbiter logic may look at parameters such as current mainband usage, predicted mainband usage, and/or some other parameter that may indicate whether the mainband has sufficient bandwidth to accommodate transferral of the data from the sideband to the mainband. Such identification may be based on, for example, comparison to a pre-determined or dynamic threshold, or some other factor. If the mainband is identified at 215 to be completely utilized, then the data may be output to the sideband at 225. However, if the mainband is not completely utililized, then the data may be output at 220 to the PHY layer 140 for transferral on the mainband (e.g., as described above with respect to elements 140 and 150).

It will be noted that the above-described process is intended as one example process in accordance with one embodiment, and other embodiments may include more/fewer/different elements than depicted. For example, based on the UCIe link state as may be identified by the transfer manager logic 115 and/or the transfer arbiter logic 130, the transfer arbiter logic 130 may store the data locally and not transmit any data if the UCIe link is in low power state and send the data when the UCIe link is active (e.g., when the mainband of the UCIe link is re-activated).

Various implementations of embodiments herein may include or relate to one or more of the following example elements (and/or some other additional or alternative element). One such element may include the ability to advertisement of dynamic switching capability. For example, it may be desirable to allow the transfer manager logic and/or transfer arbiter logic to advertise the ability of the UCIe transmitter and receiver to support the described dynamic switching, that is support for dynamic switching of data transmission between the sideband and mainband connection through the capability register set. In some embodiments, it may further be desirable to allow for advertisement of protocol(s) that can be switched between the sideband and the mainband connection.

Another such element may relate to programming of the UCIe transmitter and receiver to enable the dynamic switching of data type/protocol between the sideband and mainband connection. Note, in some embodiments the transmitter of the data can determine and facilitate the transmission as described above with respect to such programming may include or relate to ensuring the ordering of data packets within a stream of data when the data transmission is switched between the sideband and the mainband connections. Ordering could be maintained by using the identifiers of the source of data or synchronization packets if the data packets within a stream are switched between the sideband and the mainband connection.

Other implementations may require one or more of negotiation between the transmitter and receiver to establish a contract indicating which data type/protocol can be moved between sideband and mainband connection and/or static programming of new “Register Set” to indicate which data type/protocols may be switched between sideband and mainband while other datatypes/protocols may not be switched between the sideband and the mainband connection.

Based on the implementation of embodiments herein, although the data transfer meant for sideband may be delegated to mainband, when the mainband connection is being utilized for certain specific use-case and all other functional data transfers are not active, the data (e.g., debug data) could be moved back to the sideband connection.

Example Usage Scenarios

Embodiment may provide advantages in a variety of different usage scenarios. The following describes an example debug use-case for the sake of discussion of embodiments herein. The debug use-case may relate to routing of a specific type of debug data through the sideband, and bandwidth-intensive debug data may be routed over the mainband. (Examples of debug data may include or relate to manufacturing, telemetry, diagnostics, debug, test modes, performance, manageability, etc.).

In general, it may be desirable for platform debug to be non-invasive. Bugs that occur due to the invasiveness of observing the system may be problematic. Embodiments may reduce or eliminate the occurrence of such bugs. Some debug transfers may be required to be guaranteed delivery (e.g., joint test action group (JTAG) Scans, run-control operation, some tracing), while for others a best effort is sufficient (e.g., most of the software and firmware tracing). In embodiments herein, the Transfer Arbiter may receive sufficient meta-data (QoS, Bandwidth need, power states, etc.) to decide if the data transfer should happen over mainband, sideband, or if the data transfer should be buffered for a later extraction.

### Example

The following provides an example in which the debug user has different preferences and therefore programs the transfer arbiter logic differently. The transfer arbiter logic may identify or have previously identified that a trace source sends frequent burst of trace data.

Stable System, Least Invasive:

The transfer arbiter logic will store the data in a local buffer until the mainband will be woken up and transfer the data stored in the buffer along the functional traffic.

This mechanism may reduce or eliminate unnecessary link bring-up, and therefore saves power. The data also remains as long as possible close to the source and might be extracted by software on the system itself. Neither mainband nor sideband are affected.

Relatively Stable System, Platform Focus:

The transfer arbiter logic may use the buffer to cope with the bursts and then slowly extract the data over sideband.

Again, as in the scenario above, this mechanism may reduce or eliminate any unnecessary link bring-up. The complete sideband bandwidth is efficiently used for low-invasive transfers. Mainband is not impacted at all.

Unstable System:

The user will request to get the data immediately off the system, no matter how invasive it will be. In this scenario, mainband will be needed and the overall power flow might be heavily impacted.

As seen in the example above, different scenarios have different properties and might be preferred in different use cases.

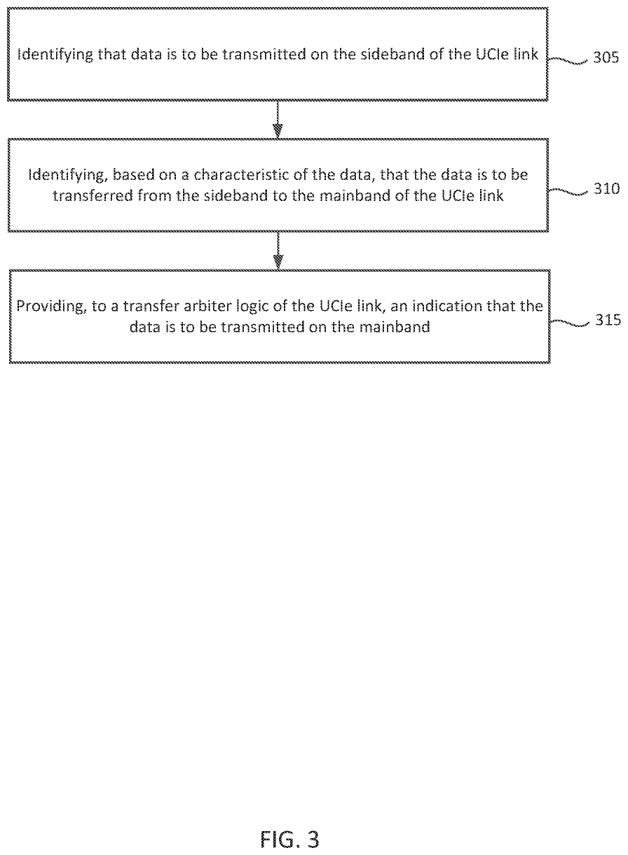

FIG. 3 illustrates an example technique that may be performed by transfer manager logic such as transfer manager logic 115 of a universal component interconnect express (UCIe) link that includes a mainband and a sideband. The process may include identifying, at 305, that data is to be transmitted on the sideband of the UCIe link; identifying, at 310 based on a characteristic of the data, that the data is to be transferred from the sideband to the mainband of the UCIe link; and providing, at 315 to a transfer arbiter logic of the UCIe link, an indication that the data is to be transmitted on the mainband.

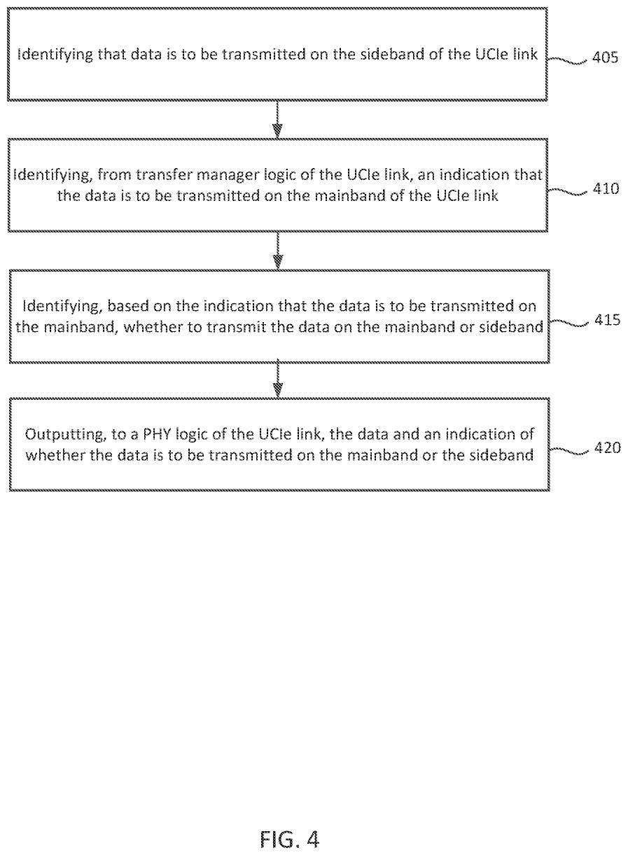

FIG. 4 illustrates an example technique that may be performed by transfer arbiter logic such as transfer arbiter logic 130 of a universal component interconnect express (UCIe) link that includes a mainband and a sideband. The process may include identifying, at 405, a data that is to be transmitted on the sideband of the UCIe link; identifying, at 410 from transfer manager logic of the UCIe link, an indication that the data is to be transmitted on the mainband of the UCIe link; identifying, at 415 based on the indication that the data is to be transmitted on the mainband, whether to transmit the data on the mainband or sideband; and outputting, at 420 to a physical layer (PHY) logic of the UCIe link, the data and an indication of whether the data is to be transmitted on the mainband or the sideband.

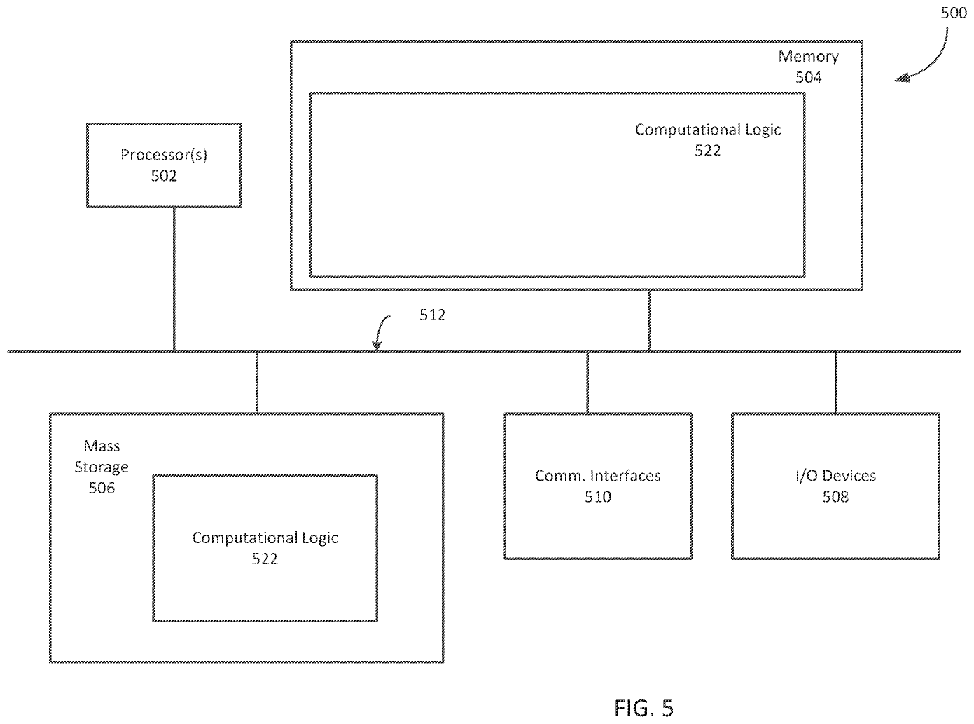

FIG. 5 illustrates an example computing device 500 suitable for use to practice aspects of the present disclosure, in accordance with various embodiments. For example, the example computing device 500 may be suitable to implement the functionalities, methods, techniques, or processes, in whole or in part, described herein.

As shown, computing device 500 may include one or more processors 502, each having one or more processor cores, and system memory 504. The processor 502 may include any type of unicore or multi-core processors. Each processor core may include a central processing unit (CPU), and one or more level of caches. The processor 502 may be implemented as an integrated circuit. The computing device 500 may include mass storage devices 506 (such as diskette, hard drive, volatile memory (e.g., dynamic random access memory (DRAM)), compact disc read only memory (CD-ROM), digital versatile disk (DVD) and so forth). In general, system memory 504 and/or mass storage devices 506 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 500 may further include input/output (I/O) devices 508 such as a display, keyboard, cursor control, remote control, gaming controller, image capture device, one or more three-dimensional cameras used to capture images, and so forth, and communication interfaces 510 (such as network interface cards, modems, infrared receivers, radio receivers (e.g., Bluetooth), and so forth). I/O devices 508 may be suitable for communicative connections with three-dimensional cameras or user devices. In some embodiments, I/O devices 508 when used as user devices may include a device necessary for implementing the functionalities of receiving an image captured by a camera.

The communication interfaces 510 may include communication chips (not shown) that may be configured to operate the device 500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments.

The above-described computing device 500 elements may be coupled to each other via system bus 512, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions implementing the operations, functionalities, techniques, methods, or processes, in whole or in part, described herein, generally shown as computational logic 522. Computational logic 522 may be implemented by assembler instructions supported by processor(s) 502 or high-level languages that may be compiled into such instructions.

The permanent copy of the programming instructions may be placed into mass storage devices 506 in the factory, or in the field, though, for example, a distribution medium (not shown), such as a compact disc (CD), or through communication interfaces 510 (from a distribution server (not shown)).

In some embodiments, elements of the UCIe link (e.g., the link as shown in FIG. 1 or 2) may be an element of a communications interface such as one of interfaces 510, and/or an element of the system bus 512 that communicatively connects various elements of FIG. 5.

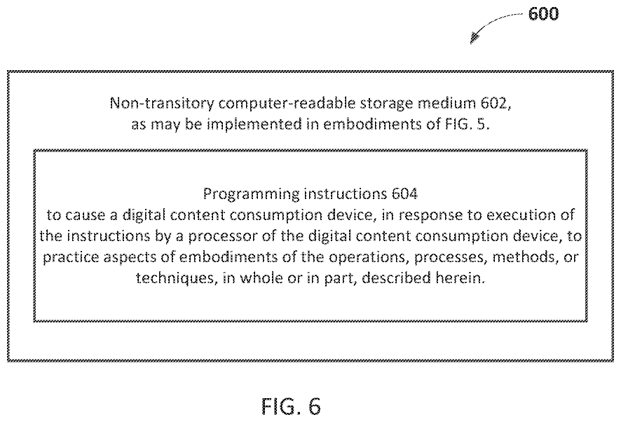

FIG. 6 illustrates an example non-transitory computer-readable storage media 602 having instructions configured to practice all or selected ones of the operations associated with the processes described above. As illustrated, non-transitory computer-readable storage medium 602 may include a number of programming instructions 604. Programming instructions 604 may be configured to enable a device, e.g., computing device 500, in response to execution of the programming instructions, to perform one or more operations, processes, methods, or techniques, in whole or in part, described herein. In alternate embodiments, programming instructions 604 may be disposed on multiple non-transitory computer-readable storage media 602 instead. In still other embodiments, programming instructions 604 may be encoded in transitory computer-readable signals.

In the preceding description, various aspects of the illustrative implementations were described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations were set forth in order to provide a thorough understanding of the illustrative implementations. It will be apparent to one skilled in the art that embodiments of the present disclosure may be practiced without the specific details. In other instances, well-known features have been omitted or simplified in order not to obscure the illustrative implementations.

In the preceding detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the detailed description is not to be taken in a limiting sense.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). More generally, various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The description may have used perspective-based descriptions such as top/bottom, in/out, over/under, and the like. Such descriptions were used to facilitate the discussion and were not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

Example 1 includes a method to be performed by transfer manager logic of a universal component interconnect express (UCIe) link that includes a mainband and a sideband, wherein the method comprises: identifying that data is to be transmitted on the sideband of the UCIe link; identifying, based on a characteristic of the data, that the data is to be transferred from the sideband to the mainband of the UCIe link; and providing, to a transfer arbiter logic of the UCIe link, an indication that the data is to be transmitted on the mainband.

Example 2 includes the method of example 1, and/or some other example herein, wherein the characteristic of the data is related to a size of the data or a type of the data.

Example 3 includes the method of any of examples 1-2, and/or some other example herein, wherein the characteristic of the data is related to a priority of the data.

Example 4 includes the method of any of examples 1-3, and/or some other example herein, wherein the characteristic of the data is related to a packet ordering requirement of the data.

Example 5 includes the method of any of examples 1-4, and/or some other example herein, wherein the characteristic of the data is related to a quality of service requirement of the data.

Example 6 includes the method of any of examples 1-5, and/or some other example herein, wherein the identification that the data is to be transferred from the sideband to the mainband is further based on a power state of the UCIe link.

Example 6.5 includes the method of any of examples 1-6, and/or some other example herein, wherein the transfer arbiter logic is configured to output, to a physical layer (PHY) logic of the UCIe link based on the indication, the data and an indication of whether the data is to be transmitted on the mainband or the sideband

Example 7 includes a method to be performed by transfer arbiter logic of a universal component interconnect express (UCIe) link that includes a mainband and a sideband, wherein the method comprises: identifying a data that is to be transmitted on the sideband of the UCIe link; identifying, from transfer manager logic of the UCIe link, an indication that the data is to be transmitted on the mainband of the UCIe link; identifying, based on the indication that the data is to be transmitted on the mainband, whether to transmit the data on the mainband or sideband; and outputting, to a physical layer (PHY) logic of the UCIe link, the data and an indication of whether the data is to be transmitted on the mainband or the sideband.

Example 8 includes the method of example 7, and/or some other example herein, wherein the identifying whether to transmit the data on the mainband or sideband is based on a characteristic of the UCIe link.

Example 9 includes the method of example 8, and/or some other example herein, wherein the characteristic relates to a power state of the UCIe link.

Example 10 includes the method of example 8, and/or some other example herein, wherein the characteristic relates to a utilization of the UCIe link.

Example 11 includes the method of any of examples 7-10, and/or some other example herein, wherein the indication received from the transfer manager logic is based on a characteristic of the data.

Example 12 includes the method of any of examples 7-11, and/or some other example herein, wherein the indication received from the transfer manager logic is based on a power state of the UCIe link.

Example Z01 may include an apparatus comprising means to perform one or more elements of a method described in or related to any of the examples herein, and/or any other method, process, or technique process described herein, or portions or parts thereof.

Example Z02 may include an apparatus comprising logic, modules, or circuitry to perform one or more elements of a method described in or related to any of the examples herein, and/or any other method, process, or technique described herein, or portions or parts thereof.

Example Z03 may include a method, technique, or process as described in or related to any of the examples herein, and/or any other method, process, or technique described herein, or portions or parts thereof.

Example Z04 may include a signal as described in or related to any of the examples herein, and/or any other method, process, or technique described herein, or portions or parts thereof.

Example Z05 may include an apparatus comprising one or more processors and non-transitory computer-readable media that include instructions which, when executed by the one or more processors, are to cause the apparatus to perform one or more elements of a method described in or related to any of the examples herein, and/or any other method, process, or technique described herein, or portions or parts thereof.

Example Z06 may include one or more non-transitory computer readable media comprising instructions that, upon execution of the instructions by one or more processors of an electronic device, are to cause the electronic device to perform one or more elements of a method described in or related to any of the examples herein, and/or any other method, process, or technique described herein, or portions or parts thereof.

Example Z07 may include a computer program related to one or more elements of a method described in or related to any of the examples herein, and/or any other method, process, or technique described herein, or portions or parts thereof.

1. An electronic device comprising:
a universal component interconnect express (UCIe) link that includes a mainband and a sideband; and
transfer manager logic configured to:
identify that data is to be transmitted on the sideband of the UCIe link;
identify, based on a characteristic of the data, that the data is to be transferred from the sideband to the mainband of the UCIe link; and
provide, to a transfer arbiter logic, an indication that the data is to be transmitted on the mainband.

2. The electronic device of claim 1, wherein the characteristic of the data is related to a size of the data or a type of the data.

3. The electronic device of claim 1, wherein the characteristic of the data is related to a priority of the data.

4. The electronic device of claim 1, wherein the characteristic of the data is related to a packet ordering requirement of the data.

5. The electronic device of claim 1, wherein the characteristic of the data is related to a quality of service requirement of the data.

6. The electronic device of claim 1, wherein the identification that the data is to be transferred from the sideband to the mainband is further based on a power state of the UCIe link.

7. The electronic device of claim 1, wherein the transfer arbiter logic is configured to output, to a physical layer (PHY) logic of the UCIe link based on the indication, the data and an indication of whether the data is to be transmitted on the mainband or the sideband.

8. An electronic device comprising:
a universal component interconnect express (UCIe) link that includes a mainband and a sideband; and
transfer arbiter logic configured to:
identify a data that is to be transmitted on the sideband of the UCIe link;
identify, from transfer manager logic of the UCIe link, an indication that the data is to be transmitted on the mainband of the UCIe link;
identify, based on the indication that the data is to be transmitted on the mainband, whether to transmit the data on the mainband or sideband; and
output, to a physical layer (PHY) logic of the UCIe link, the data and an indication of whether the data is to be transmitted on the mainband or the sideband.

9. The electronic device of claim 8, wherein the identification of whether to transmit the data on the mainband or sideband is based on a characteristic of the UCIe link.

10. The electronic device of claim 9, wherein the characteristic relates to a power state of the UCIe link.

11. The electronic device of claim 9, wherein the characteristic relates to a utilization of the UCIe link.

12. The electronic device of claim 8, wherein the indication received from the transfer manager logic is based on a characteristic of the data.

13. The electronic device of claim 8, wherein the indication received from the transfer manager logic is based on a power state of the UCIe link.

14. An electronic device comprising:
a universal component interconnect express (UCIe) link that includes a mainband and a sideband;
transfer manager logic configured to:
identify that data is to be transmitted on the sideband of the UCIe link;
identify, based on a characteristic of the data, that the data is to be transferred from the sideband to the mainband of the UCIe link; and
provide, to a transfer arbiter logic, an indication that the data is to be transmitted on the mainband; and
transfer arbiter logic configured to:
identify a data that is to be transmitted on the sideband of the UCIe link;
identify, from transfer manager logic of the UCIe link, an indication that the data is to be transmitted on the mainband of the UCIe link;
identify, based on the indication that the data is to be transmitted on the mainband, whether to transmit the data on the mainband or sideband; and
output, to a physical layer (PHY) logic of the UCIe link, the data and an indication of whether the data is to be transmitted on the mainband or the sideband.

15. The electronic device of claim 14, wherein the identification by the transfer arbiter logic of whether to transmit the data on the mainband or sideband is based on a characteristic of the UCIe link.

16. The electronic device of claim 15, wherein the characteristic relates to a power state of the UCIe link.

17. The electronic device of claim 15, wherein the characteristic relates to a utilization of the UCIe link.

18. The electronic device of claim 14, wherein the indication provided by the transfer manager logic to the transfer arbiter logic is based on a characteristic of the data.

19. The electronic device of claim 18, wherein the characteristic of the data is related to a size of the data or a type of the data, a priority of the data, a packet ordering requirement of the data, or a quality of service requirement of the data.

20. The electronic device of claim 14, wherein the indication provided by the transfer manager logic to the transfer arbiter logic is based on a power state of the UCIe link.
